(19) United States
(12) Patent Application Publication
(10) Pub. No.: US 2004/0169926 A1
(43) Pub. Date: Sep. 2, 2004

(54) Module assembly for fiber optic isolator

(75) Inventors: Alan Blair, St. Paul, MN (US); Thomas J. Schmitt, Apple Valley, MN (US); James Kochendorfer, Plymouth, MN (US); Craig Robilliard, Lyneham (AU); John C. Holman, Coon Rapids, MN (US)

Correspondence Address: CARLSON, CASPERS, VANDENBURGH & LINDQUIST, 225 SO. 6TH STREET, SUITE 3200, MPIS, MN, 55402, US

(73) Assignee: ADC Telecommunications, Inc., Eden Prairie, MN

(21) Appl. No.: 10/656,919

(22) Filed: Sep. 5, 2003

Related U.S. Application Data
(60) Provisional application No. 60/409,921, filed on Sep. 10, 2002.

(51) Int. Cl. G02B 5/30; G02B 27/28

(52) U.S. Cl. 359/494

(57) ABSTRACT

An isolator unit includes a mount for mounting three isolator components, resulting in a smaller package. The isolator components are attached to the mount using a technique that reduces the possibility that the orientations of the components change with a change in temperature. Consequently, the operational characteristics of the isolator have a reduced temperature dependence.

### FIELD OF THE INVENTION

The present invention is directed generally to fiber optical devices, and more particularly to an approach for mounting optical elements in an isolator used in fiber optical devices.

### BACKGROUND

Optical fibers find many uses for directing beams of light between two points. Optical fibers have been developed to have low loss, low dispersion, polarization maintaining properties and can be incorporated into several different types of devices, such as amplifiers, filters, lasers and interferometers. As a result, optical fiber systems find widespread use, for example in optical communications.

However, one of the important advantages of fiber optic beam transport, that of enclosing the optical beam to guide it between terminal points, is also a limitation. There are several optical components, important for use in fiber systems or in fiber system development, that are not implemented in a fiber-based form where the optical beam is guided in a waveguide. Instead, these optical components are implemented in a bulk form, and through which the light propagates freely. Examples of such components include, but are not limited to, filters, isolators, circulators, polarizers, switches and shutters. Consequently, the inclusion of a bulk component in an optical fiber system necessitates that the optical fiber system have a section where the beam path propagates freely in space, rather than being guided within a fiber.

Free space propagation typically requires use of collimation units at the ends of the fibers to produce and receive collimated beams. In some units, the same focusing element is used to collimate the beams from two different fibers placed at different positions relative to the axis of the focusing optic. This produces collimated beams that propagate in non-parallel directions. The non-parallel propagation of the collimated beams introduces extra issues for aligning the components of the device, and may place some limits on making the device smaller in size.

A fiber optical device typically includes a collimation unit at each end, to produce a collimated light beam in the region of free-space propagation. The collimation unit typically includes one or more lenses to collimate the light passing to or from a fiber. Bulk optical elements, such as filters, polarizers, and isolator units having birefringent elements and non-reciprocating elements, are disposed in the collimated light beam, or light beams to perform the desired function. It is particularly important to hold the optical elements of an isolator parallel to teach other and at a particular angle relative to the light beam passing through the isolator. Failure to ensure the correct orientation of the isolator elements or the isolator unit itself may result in a reduction in the performance of the isolator. There is a need, therefore, to ensure that the isolator's elements are mounted at the desired position and orientation. It is also important that the desired position and orientation of the isolator's elements are maintained over a range of possible operating temperatures.

### SUMMARY OF THE INVENTION

Accordingly, there is a need for an improved approach to mounting optical elements in an isolator for use in a fiber optic device that improves the positioning and orientation of the elements and that reduces the temperature dependent variation of their position and orientation.

One embodiment of the present invention is directed to an optical isolator device for use in a predetermined temperature range. The optical isolator includes an isolator arrangement of at least a first birefringent crystal, a non-reciprocal element and a second birefringent crystal. A mount has a first mounting surface provided with a first protruding contact region. At least one of the first birefringent crystal, the non-reciprocal element and the second birefringent crystal has a second mounting surface contacting the protruding contact region. Adhesive is attachingly disposed between portions of the first and second mounting surfaces not in mutual contact.

Another embodiment of the invention is directed to an optical system, that has an optical transmitter producing output light, an optical receiver receiving at least a portion of the output light, and an optical fiber link coupling between the optical transmitter and the optical receiver. The optical fiber link includes a fiber isolator device having an isolator arrangement of at least a first birefringent crystal, a non-reciprocal element and a second birefringent crystal forming an isolator unit. A mount has a first mounting surface provided with a first protruding contact region, and at least one of the first birefringent crystal, the non-reciprocal element and the second birefringent crystal has a second mounting surface contacting the protruding contact region. Adhesive is attachingly disposed between portions of the first and second mounting surfaces not in mutual contact.

Another embodiment of the invention is directed to a method of mounting optical elements to a mount in an optical isolator for use in a predetermined temperature range, the mount having a first protruding contact region on a mounting surface, and the isolator having an isolator arrangement that includes at least a first birefringent crystal, a non-reciprocal element and a second birefringent crystal. The method includes providing adhesive between at least one of the first birefringent crystal, the non-reciprocal element and the second birefringent crystal, and pressing the at least one of the first birefringent crystal, the non-reciprocal element and the second birefringent crystal into contact with the first protruding contact region thereby substantially expelling the adhesive from between the at least one of the first birefringent crystal, the non-reciprocal element and the second birefringent crystal and the first protruding contact region. The adhesive is cured at a temperature exceeding the predetermined temperature range.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a fiber optic communications system in accordance with an embodiment of the present invention;

FIG. 2 schematically illustrates an embodiment of a fiber optic isolator device according to the present invention;

FIGS. 3A and 3B schematically illustrate a type of optical isolator that may be used with the present invention;

FIG. 4 schematically illustrates an embodiment of a WDM device including an isolator according to the present invention;

FIG. 5 schematically illustrates a partial cross-section of a conventional fiber optic device;

FIGS. 6A and 6B schematically illustrate a partial cross-section of a mount, before and after mounting an optical element respectively, according to an embodiment of the present invention;

FIGS. 7A and 7B schematically illustrate a mounting bracket for an optical isolator according an embodiment of the present invention; and

FIG. 8 schematically illustrates another embodiment of an optical isolator according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to fiber optic devices, and is believed to be particularly useful with fiber optic devices that include optical elements that are face-mounted within the device. Face-mounted elements include, for example, filters such as may be used in wavelength division multiplexed (WDM) devices or tap monitors, polarizers, birefringent plates, polarization rotators and the like. The present invention is particularly directed to optical isolators.

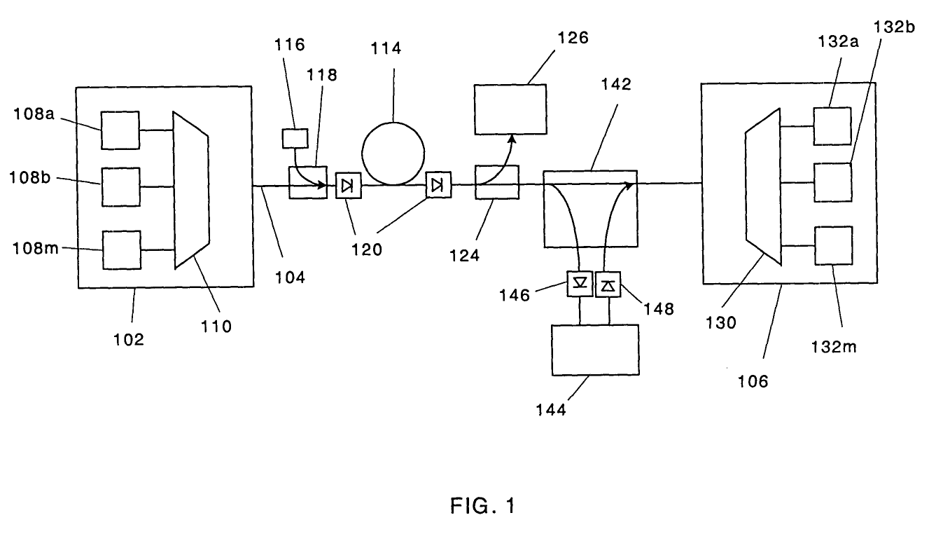

A schematic of an embodiment of an optical communications system 100 is presented in FIG. 1. A DWDM transmitter 102 directs a DWDM signal having m channels through a fiber communications link 104 to a DWDM receiver 106.

In this particular embodiment of DWDM transmitter 102, a number of light sources 108a, 108b-108m generate light at different wavelengths, λa, λb . . . λm, corresponding to the different optical channels. The light output from the light sources 108a-108m is combined in a DWDM combiner unit 110, or multiplexer (MUX) unit, to produce a DWDM output 112 propagating along the fiber link 104.

Light sources 108a-108m are typically laser sources whose output is externally modulated, although they may also be modulated laser sources, or the like. It will be appreciated that the DWDM transmitter 102 may be configured in many different ways to produce the DWDM output signal. For example, the MUX unit 110 may include an interleaver to interleave the outputs from different multiplexers. Furthermore, the DWDM transmitter 102 may be equipped with any suitable number of light sources for generating the required number of optical channels. For example, there may be twenty, forty or eighty optical channels, or more. The DWDM transmitter 102 may also be redundantly equipped with additional light sources to replace failed light sources.

Upon reaching the DWDM receiver 106, the DWDM signal is passed through a demultiplexer unit (DMUX) 130, which separates the multiplexed signal into individual channels that are directed to respective detectors 132a, 132b-132m.

The fiber link 104 may include one or more fiber amplifier units 114, for example rare earth-doped fiber amplifiers, Raman fiber amplifiers or a combination of rare earth-doped and Raman fiber amplifiers. The pump light may be introduced to the fiber amplifier 114 from a pump unit 116 via a coupler 118. Optical isolators 120 may be positioned along the fiber link 104 to prevent light from passing in the backwards direction. For example isolators 120 may be positioned on either side of the amplifier 140 to reduce the possibility of backscattered light, propagating towards to the transmitted 102, from being amplified in the amplifier 114.

The fiber link 104 may include one or more DWDM channel monitors 126 for monitoring the power in each of the channels propagating along the link 104. Typically, a fraction of the light propagating along the fiber link 104 is coupled out by a tap coupler 124 and directed to the DWDM channel monitor 126. The fiber link 104 may also include one or more gain flattening filters (not illustrated), typically positioned after an amplifier unit 114, to make the power spectrum of different channels flat. The channel monitor 126 may optionally direct channel power profile information to the gain flattening filter. The gain flattening filter may, in response to the information received from the channel monitor 126, alter the amount of attenuation of different channels in order to maintain a flat channel power profile, or a channel power profile having a desired profile.

The fiber link 104 may include one or more optical add/drop multiplexers (OADM) 142 for directing one or more channels td a local fiber system 144. The local loop 144 may also direct information back to the OADM 142 for propagating along the fiber link 104 to the DWDM receiver 106. It will be appreciated that the information directed from the local fiber system 144 to the OADM 142 need not be at the same wavelength as the information directed to the local loop 144 from the OADM 142. Furthermore, it will be appreciated that the OADM 142 may direct more than one channel to, and may receive more than one channel from, the local system 144. The amount of light being added to the fiber link 104 from the local system 144 may be monitored by a channel monitor to ensure that the light in the channel(s) being added to the fiber link has an amplitude similar to that of the existing channels. Isolators 146 and 148 may be positioned between the fiber link 104 and the local system 144 to reduce the possibility that light propagates in the fiber link 104 in an undesired direction.

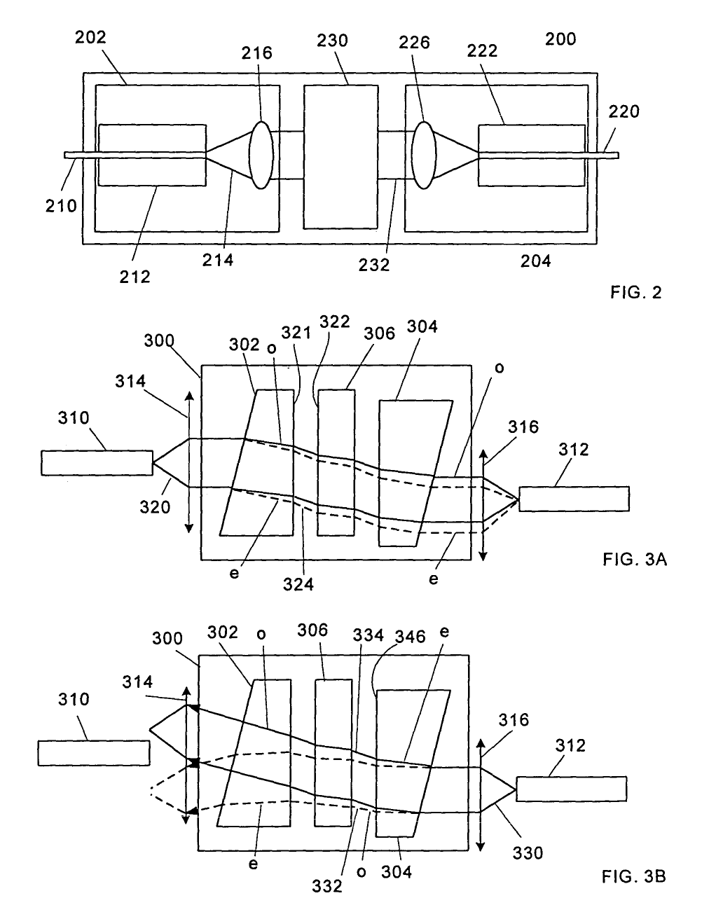

One type of isolator device 200, that may be referred to as an in-line isolator, is schematically illustrated in FIG. 2. The device 200 includes two single fiber collimators (SFCs) 202 and 204. The first SFC 202 includes a fiber 210 mounted in a ferrule 212. Light 214 from the output end of the fiber 210 is collimated by the focusing unit 216, which may include one or more lenses. The collimated beam 218 passes to the isolator unit 230. The light 232 transmitted through the isolator unit 230 is directed to the second SFC 204. The light 232 is focused by a focusing unit 226 to the input end of the second fiber 220. The second fiber 220 is held in the second ferrule 222.

Therefore, light passes from the first fiber 210 to the second fiber 220 in the forward direction. In the reverse direction, however, the light 224 that expands from the second fiber 220 is collimated by the second focusing unit 226 and passes into the isolator unit 230. The resulting light 234 transmitted through the isolator unit 230 is not directed to the first fiber 210, but is deviated in some manner, depending on the design of the isolator unit 230.

One embodiment of isolator unit 300 is now described with respect to FIGS. 3A and 3B. A similar type of isolator is further described in U.S. Pat. No. 4,548,478, which is incorporated by reference.

The isolator unit 300 is positioned between first and second fibers 310 and 312 and respective first and second collimating lenses 314 and 316. The passage of light from the first fiber 310 to the second fiber 312 is illustrated in FIG. 3A, while the passage of light from the second fiber 312 to the first fiber 310 is illustrated in FIG. 3B.

First, with respect to FIG. 3A, light 320 diverges from the first fiber 320 and is collimated by the first collimating lens 314. The collimated light enters the first birefringent crystal 302. Light passing through the first crystal 302 as an ordinary wave, labeled “o”, propagates as a first ray 322 in a first direction, while light passing through the first crystal 302 as an extraordinary wave, labeled “e”, propagates as a second ray 324 in a second direction different from the first direction. The first ray 322 is refracted at the angled surface 321 of the first crystal 302. The second ray 324 is incident on the angled surface 321 at a smaller angle of incidence than the first ray 322, and is refracted to a lesser extent. The second ray 324 may be normally incident on the angled surface 321.

The first and second rays 322 and 324 pass through the non-reciprocal polarization rotator 306, where the polarization of each ray is rotated through approximately 45°. The first and second rays 322 and 324 then propagate to the second birefringent crystal 304. The optical axis of the second birefringent crystal 304 is rotated 45° relative to the optical axis of the first birefringent crystal 302. Therefore, the first ray 322 passes through the second birefringent crystal 304 as an ordinary wave, while the second ray 324 passes through the second birefringent crystal as an extraordinary wave.

The two rays 322 and 324 emerge from the second birefringent crystal mutually parallel and are focused by the second collimating lens 316 into the second fiber 312. Thus, irrespective of the polarization of the light 320 transmitted by the first fiber 310, the light 320 is transmitted to the second fiber 312.

Next, we examine the propagation of light from the second fiber 312 to the first fiber 310 with reference to FIG. 3B. Light 330 diverges from the second fiber 312 and is collimated by the second collimating lens 316. The collimated light enters the second birefringent crystal 304. Light passing through the second birefringent crystal 304 as an ordinary wave, labeled “o”, propagates as a first ray 332 in a first direction, while light passing through the second crystal 304 as an extraordinary wave, labeled “e”, propagates as a second ray 334 in a second direction different from the first direction. The first ray 332 is refracted at the angled surface 336 of the second crystal 304. The second ray 334 is incident on the angled surface 336 at a smaller angle of incidence than the first ray 332, and is refracted to a lesser extent. The second ray 334 may be normally incident on the angled surface 336.

The first and second rays 332 and 334 pass through the non-reciprocal polarization rotator 306, where the polarization of each ray is rotated through approximately 45°. However, since the rays 332 and 334 are propagating in the opposite direction to the rays 322 and 324, the handedness of the polarization rotation is different. The first and second rays 332 and 334 then propagate to the first birefringent crystal 302. The optical axis of the first birefringent crystal 302 is rotated 45° relative to the optical axis of the second birefringent crystal 304. However, the direction of this relative rotation is opposite the direction of polarization rotation. Therefore, the first ray 332, having passed through the second crystal as an ordinary ray, passes through the first birefringent crystal 302 as an extraordinary wave, marked “e.” Also, the second ray 334, having passed through the second crystal 304 as an extraordinary ray, passes through the first birefringent crystal 302 as an ordinary wave, marked “o”.

In the forward direction, the two wedged birefringent crystals operate as a complementary prism pair, so that light exiting from the second crystal is parallel to the direction in which light entered the first crystal 302. In other words, the deviation caused by one wedge is compensated for by the other wedge. However, since light propagating in the backward direction passes through one crystal as an “o” ray and in the other crystal as an “e” ray, the two wedged crystals 302 and 304 do not act as a complementary prism pair, and the two rays 332 and 334 emerge from the first birefringent crystal 302 in different directions. Accordingly, neither ray 332 nor ray 334 is focused by the first collimating lens to the first fiber 310. Thus, irrespective of the polarization of the light 330 transmitted by the second fiber 312, the light 330 is not transmitted to the first fiber 310. Therefore, the isolator module 300 is effective as a polarization insensitive isolator.

An isolator unit may also be included with other optical elements in a fiber optic device. For example, an isolator may be used in a filter-based device, where the filter is used to separate a portion of light from a signal. The filter may separate a fraction of the incident light over the entire spectrum, for example for use in a tap or channel monitor. The filter may also separate light having one or more particular wavelengths, for example in a wavelength division multiplexer or add/drop multiplexer.

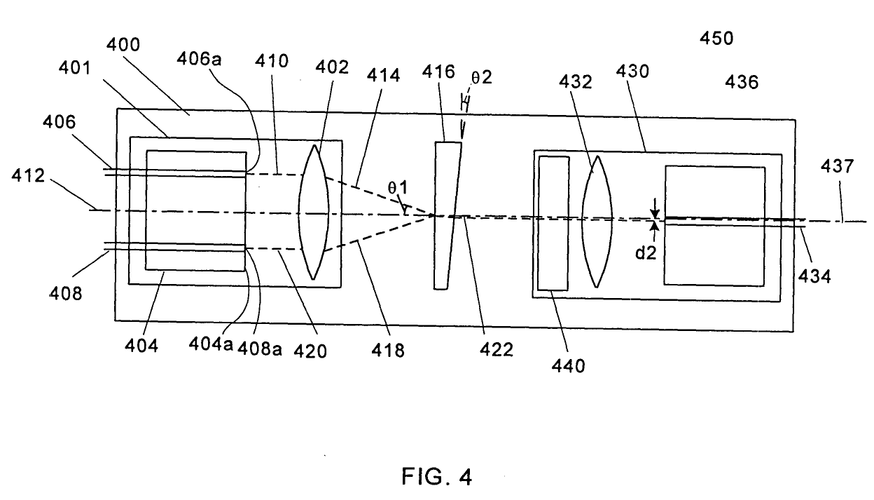

One particular embodiment of a filter-based fiber optic device that incorporates an isolator is schematically illustrated in FIG. 4, which shows a dual fiber collimator (DFC) 401 coupling light to an SFC 430. The DFC 401 includes two fibers 406 and 408 held in a dual-fiber ferrule 404. The ferrule end 404a and the fiber ends 406a and 408a may be polished at a small angle, for example in the range 1°-8°, to prevent reflections feeding to other elements. It will be understood that some of the beams, for example beam 410 from the first fiber 406, may be diverging or converging or may, like beam 414, be substantially collimated.

Beam 410 from the first fiber 406 diverges towards the focusing unit 402, implemented in the illustrated embodiment as a lens. The lens 402 may be any suitable type of lens, such as a spherical or aspherical lens, having at least one curved surface, or may be a gradient index (GRIN) lens. Beam 414 propagating from the lens 402 is substantially collimated and, since the first fiber 406 is positioned at a distance d1 from the axis 412 of lens 402, beam 414 propagates at an angle θ1 relative to the axis 412.

Beam 414 is incident on the filter 416, which reflects light as beam 418 to the lens 402 which redirects and focuses the beam 420 to the second fiber 408. In this particular embodiment, the filter 416 is wedged at an angle, for example greater than around 4°, so that refraction of the transmitted beam 422 directs the beam 422 along a direction towards the SFC 430 substantially parallel to the optical axis 412 of the first lens 402. The beam 422 is focused in a second focusing unit 432 into a third fiber 434 held in a single fiber ferrule 436.

In this embodiment, the axis 437 of the SFC 430 is substantially parallel to the axis 412 of the DFC 401. An advantage provided by the embodiment 400 illustrated in FIG. 4A is that, since the axes 412 and 437 are substantially parallel to each other, it is easier to align the SFC 430 to the DFC 401, than it is to align the SFC 130 to a DFC where the light transmitted through the filter does not propagate parallel to the axis 412.

It will be appreciated that beams may propagate through the device 400 in directions different from those just described, for example so that light entering the device 400 through the second and third fibers 408 and 434 is combined at the optical element 416 and propagates to the first fiber 406.

The filter 416 may have a reflective coating on a first surface 416a and an antireflective coating on a second surface 416b. Such an optical element 416 may permit the device to operate as a multiplexer (MUX) or, a demultiplexer (DMUX), or an optical add-drop multiplexer (OADM). In an example illustrating the operation of a MUX, light at one wavelength, or wavelength range, may enter the device through the second fiber 408, and be reflected by the filter element 416 towards the first fiber 408. Light at another wavelength, or wavelength range, may enter the device through the third fiber 434 and be transmitted to the first fiber 406 through the filter 416. Thus, the output from the first fiber 406 is a combination of the light entering the device from both the second and third fibers 406 and 434.

In an example illustrating the operation of a DMUX, light having components at two different wavelengths, or wavelength ranges, may enter the device through the first fiber 406. Light at one of the wavelengths or wavelength ranges is reflected by the filter 416 towards the second fiber 408 while light at the other wavelength or wavelength range is transmitted to the third fiber 434.

The light entering the device may, instead of comprising two wavelengths or wavelength ranges, include several different wavelengths to form a multiple channel optical communications signal. The filter 416 may be set to reflect light in one or more particular channels, and transmit light in the other channels. Therefore, depending on the direction of the light entering the device and the range of wavelengths over which the filter 416 is reflective, the device may drop one or more channels from the multiple channel signal or may add one or more channels to the multiple channel signal.

Optionally, an isolator 440 may be included in the device 400 between the filter and the third fiber 434 to prevent light propagating in one direction through the device 400. For example, where light having a wavelength of λ1 from the second fiber 408 is combined with light at a wavelength of λ2 from the third fiber 434, the isolator 440 may prevent the reflection of light at λ2 back to the third fiber 434.

It will be appreciated that the filter 416 need not be wedged to such as degree as to make the transmitted light 422 parallel with the axis 412. Instead, the filter need not be wedged, or may be wedged at some other angle. In such a case, the SFC is typically aligned with its axis 437 parallel to the transmitted light 422.

There is a number of important factors to consider in fabricating an isolator. First, the requirement that the isolator include multiple optical elements adds complexity in its construction, which leads to increased labor and higher costs. Therefore, it is important that the isolator should be formed from as few components as possible. It is advantageous, therefore, to employ a three-component isolator such as is illustrated above in FIGS. 3A and 3B. Second, the parallelism between the isolator's components may be compromised when the component elements are surface mounted. This is a result of variations in the thickness of the glue line, which is difficult to control, and leads to compromised isolator performance. Third, the optical characteristics of the isolator module should be relatively independent of operating temperature. Fourth, it is desirable to be able to automate the fabrication of an isolator, so as to ensure fast, reproducible manufacturing.

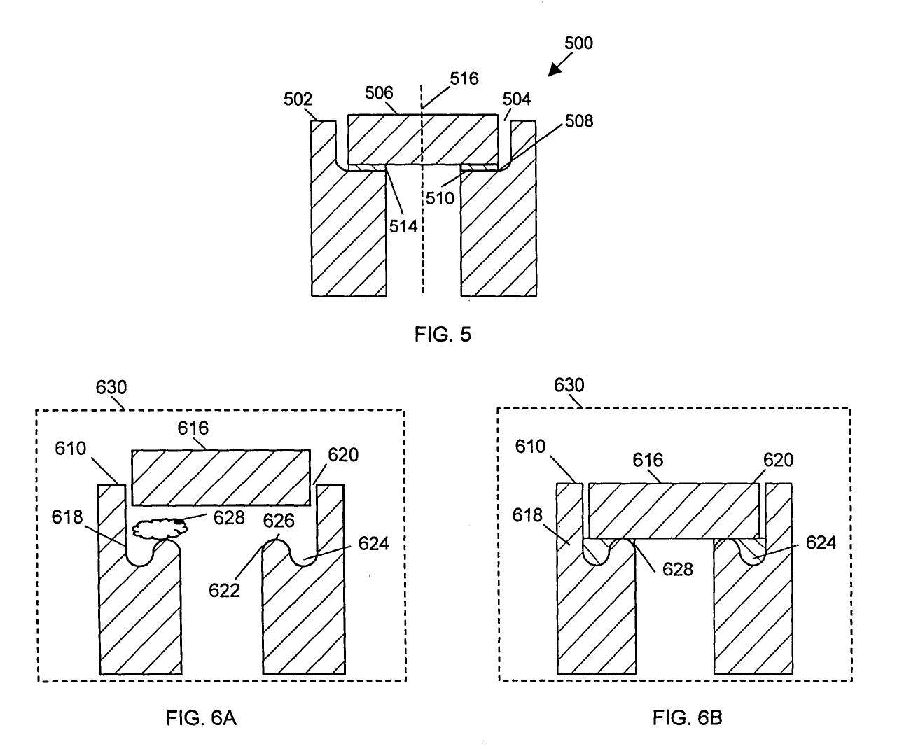

One approach to mounting elements that reduces the problems of variations in glue line thickness and temperature dependence is now discussed with respect to FIGS. 5-6B.

First, a cross-section through part of a conventional fiber device 500 that uses surface mounting is illustrated in FIG. 5. A mount 502 has a recess 504 for mounting an optical element, such as a filter, lens, polarizer, Faraday rotator, a birefringent plate, or any other type of bulk optical element that may be used in a fiber optic device. A lip 508 in the recess 504 provides a flat surface 510 against which the element 506 may be glued. However, a layer of glue 514, generally of indeterminate thickness, remains between the flat surface 510 and the element 506 due to capillary action, even after the element 506 has been pressed against the flat surface 510. The absolute thickness of the layer of glue 514 is typically not well controlled and may vary from assembly to assembly. Furthermore, the thickness of the glue layer 514 around the may vary around the element 506 so that the orientation of the element relative to the axis 516 may not be well controlled. Consequently, even if the mount 502 is fabricated with tight tolerances on its mounting faces, the uncertainty in the thickness of the glue layer 514 results in an uncertainty in the orientation of the element 506 relative to the axis 516.

Various factors may affect the thermal stability of the device 500. For example, where the layer of glue 514 is thicker on one side of the mount 502 than the other, any thermal expansion or contraction may result in a tilting of the element 506. Also, if the glue 514 is not homogeneous, for example, due to incomplete mixing of the different glue components, different regions of the glue layer 514 may manifest different temperature-dependent thicknesses, which also leads to tilting of the element 506. The optical characteristics of the device 500, such as return loss and insertion loss, may be dependent on the tilt of the element and, consequently, may change with temperature.

It is often advantageous to reduce the temperature dependence of the device characteristics, so that operation is uniform despite changing temperatures. It is also advantageous to ensure that the element 506 is mounted with an orientation relative to the mount 502 that is as precise as possible.

A cross-section view through a mount 610 that shows a different approach to face mounting components is illustrated in FIGS. 6A and 6B. This approach is referred to as a face contact mounting technique. The mounting surface 618 may be provided in a recess 620, although this is not a requirement. The element mounting surface 618 includes a raised portion 622 and may also include a well 624 on one or both sides of the raised portion 622. In the illustrated embodiment, a well 624 is provided on one side of the raised portion 622. The raised portion 622 presents a tip 626 for contacting the element 616, rather than a flat surface. The element 616 is shown close to the mounting surface 618, with adhesive 628 disposed between the element 616 and the mounting surface 618, prior to mounting.

As the element 616 is forced towards the mounting surface 618, the adhesive 628 is expelled from the region between the tip 626 and the element 616 until the element 616 contacts the tip 626. The expelled adhesive 628 flows away from the tip 626, down one or both sides of the raised portion 622, and may flow to the well 624. The well 624 need not be filled with expelled adhesive 628. Since the tip 626 has a very small area, it is possible to overcome capillary action and expel the adhesive 628 entirely from between the tip 626 and the element 616, so that the element 616 contacts the tip 626, as illustrated in FIG. 6B. The mount 610, element 616 and adhesive 628 are raised in temperature, preferably to a temperature higher than the expected operating temperature of the resulting fiber optic device. The adhesive 628 is then cured at the high temperature.

After curing, the assembly 630 comprising the mount 610, element 616 and adhesive 628 is allowed to cool. The adhesive 628 cools under tension. The adhesive 628 has a higher thermal expansion coefficient than the mount 610. As long as the operating temperature of the assembly 630 is less than the cure temperature, the adhesive 628 remains in tension, pulling the element 616 toward the mounting surface 618. Since the element 616 is in actual contact with the mounting surface 618 at the contact tips 626, the element 616 does not move relative to the mount 610 as the temperature changes within the operating range. Consequently, when the operating temperature of the assembly 630 varies, the element 616 does not tilt with respect to the mount 610, thus reducing the temperature dependence of the device's operating characteristics. For example, where the assembly 630 is employed in a tap monitor, the temperature dependence of the coupling and insertion losses may be reduced as a result of the mounting technique just described.

One example of a suitable adhesive 628 is type 353 NDT produced by Epotek Corp., Billerica, Mass. This is a two-part epoxy that is cured thermally. Furthermore, the type 353 NDT epoxy is thixotropic, which reduces the ability of the adhesive to flow even under elevated temperatures. Thus, the adhesive does not flow along the surface of the element 616 while curing. Other types of adhesive that cure at elevated temperatures may also be used.

In one particular embodiment, the mount 610 was manufactured from a martensitic, Se-doped stainless steel, type 182. The mount 610 was mounted in a jig and the mixed epoxy was applied to the mounting surface 618. The element 616, in the form of a multilayer dielectric filter formed on a substrate of B270 glass and presenting a face approximately 1.5 mm×1.5 mm to the mount 610, was forced against the mounting surface 518 with a force of 1 N, and the jig assembly was inserted into an oven for curing at 120° C. for 30 mins.

This approach to mounting elements addresses two of the important considerations listed above for isolator units. Under this approach, the optical elements contact the mounting surface of the mount. The glue line between the mounting surface and the element has been eliminated and so the element lies parallel to the mounting surface. Furthermore, this approach reduces the thermally induced variation in the position or orientation of the element, and so the operating characteristics are more constant over the range of operating temperatures.

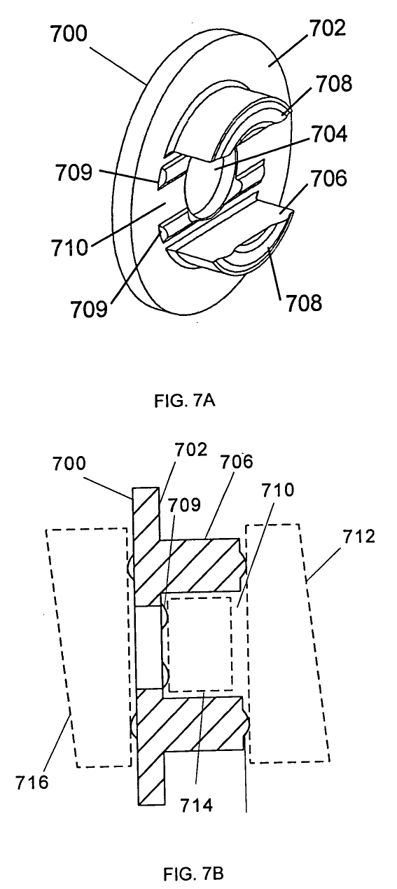

An embodiment of a bracket 700 for fabricating an isolator module is illustrated in FIGS. 7A and 7B. This bracket 700 may be used for holding up to all three of the isolator's component elements, helping to maintain a defined positional and orientational relationship among all the isolator elements. The bracket is formed from a plate 702 having an aperture 704 therethrough to allow light to pass through the isolator. Raised members 706 on one face of the plate 702 are provided with one or more protrusions 708 upon which an optical element 712 (shown in dashed lines) may be face contact mounted. The raised members 706 are separated to provide a space 710 therebetween. The face of the plate 702 is also provided with protrusions for face contact mounting an element 714 (shown in dashed lines) that sits in the space 710 between the raised members. Thus two elements 712 and 714, for example a Faraday rotator and a birefringent crystal, may be face contact mounted to one side of the bracket 700. Additional raised members may be positioned outside the first raised members 706 for face contact mounting additional elements. A third element 716, for example a second birefringent crystal, may be face contact mounted to the other side of the bracket 700.

An advantage provided by the bracket 700 is that it is well adapted to automated manufacture, where the optical elements are positioned against the bracket with a pick and place machine. The space 710 between the raised members 706 permits the non-reciprocal element 712 to be slid in between the raised members 706 prior to mounting to the bracket 700.

It will be appreciated that other elements may be face contact mounted to the bracket 700 in addition to the three illustrated in FIG. 7B. For example, the left side of the bracket 700 may be provided with raised members that provide for the mounting of one or more additional elements. Furthermore, the right side may also be provided with additional raised members, for example in a stacked manner, that permit the mounting of additional elements.

Not all the isolator's component elements require to be face contact mounted. One or more of the elements, for example the second birefringent crystal 716, may be mounted to the bracket in a conventional manner.

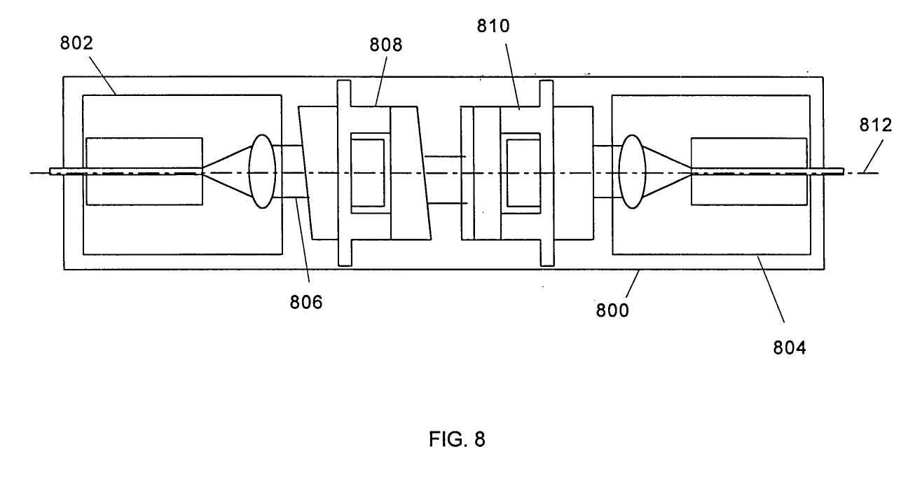

An embodiment of another isolator device 800 that uses a face contact mounted isolator module is schematically illustrated in FIG. 8. The device includes two SFC's 802 and 804. The first SFC 802 generates a collimated beam 806 that passes through two face contact mounted isolator modules 808 and 810. The isolator modules 808 and 810 may both be optimized for maximum isolation at the same wavelength or may be each be optimized for maximum isolation at different wavelengths. In the illustrated embodiment, the second isolator module 810 is rotated about the axis 812 by 90° relative to the first isolator module 808. This prevents the isolating effect of one isolator module being offset by the isolating effect of the other isolator module.

The mounting surfaces, defined by the protruding portions, may or may not be cylindrically symmetric. However, the mounting surfaces need not be uniform, for example due to manufacturing tolerances. One example of non-uniformity is that the height of the tip 626 above the well 624 may vary tangentially around the mount 610. In such a case, the element 616 may not contact the entire tip region 626 all the way around the mount 610. The element 616 does, however, contact at least three points of the raised portion 622 around the mount 610, which provides sufficient contact to prevent the element 616 from moving relative to the mount 610 under conditions of changing temperature. An advantage of this approach to face mounting optical elements is that, since the element contacts the mounting surface, the surface of the element lies in the plane defined by the mounting surface. Accordingly, the precision with which the element's surface is oriented is dependent on the precision of manufacturing the mounting surface.

It will be appreciated that the tips need not be circularly symmetric, but may be positioned at different places on the mount to provide a mounting plane for mounting the particular element. Only three highest tips are required to define a mounting plane on which the surface of the element rests.

As noted above, the present invention is applicable to fiber optic devices and is believed to be particularly useful in fiber optic isolator devices that use one or more surface-mounted elements. It will be appreciated that the invention is not restricted to mounting filters, but may be used for mounting any surface-mounted optical element. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification.

We claim:

1. An optical isolator device for use in a predetermined temperature range, comprising:
an isolator arrangement of at least a first birefringent crystal, a non-reciprocal element and a second birefringent crystal,
a mount having a first mounting surface provided with a first protruding contact region;
at least one of the first birefringent crystal, the non-reciprocal element and the second birefringent crystal having a second mounting surface contacting the protruding contact region; and
adhesive attachingly disposed between portions of the first and second mounting surfaces not in mutual contact.

2. A device as recited in claim 1, wherein at least a second one of the first birefringent crystal, the non-reciprocal element and the second birefringent crystal has a third mounting surface contacting a second protruding region of a fourth mounting surface of the mount, with adhesive attachingly disposed between the third mounting surface and the mount.

3. A device as recited in claim 2, wherein a third one of the first birefringent crystal, the non-reciprocal element and the second birefringent crystal has a fifth mounting surface contacting a third protruding region of a sixth mounting surface of the mount, with adhesive attachingly disposed between the fifth mounting surface and the mount.

4. A device as recited in claim 2, wherein one side of the mount is provided with at least two raised members, protruding regions on ends of the at least two raised members forming the second protruding region, and the at least one of the first birefringent crystal, the non-reciprocal element and the second birefringent crystal comprising the non-reciprocal element mounted to the mount in a region between the at least two raised members.

5. A device as recited in claim 4, wherein two of the at least two raised members are arranged to permit the non-reciprocal element to be translated between the two of the at least two raised members and mounted over a through aperture in the mount.

6. A device as recited in claim 1, the adhesive remains under tension for temperatures within the predetermined temperature range.

7. A device as recited in claim 1, wherein the predetermined temperature range lies within the range −20° C. to 75° C.

8. A device as recited in claim 1, wherein the protruding contact region is disposed at least partially around a light transmission aperture of the mount to define the mounting plane.

9. A device as recited in claim 1, wherein the protruding contact tip region includes at least three individual contact tips on the mounting surface to define a mounting plane.

10. A device as recited in claim 1, wherein the adhesive is a thermally cured epoxy.

11. A device as recited in claim 1, wherein the adhesive has a thermal expansion coefficient higher than a thermal expansion coefficient of the mount and than a thermal expansion coefficient of the at least the first birefringent crystal, the non-reciprocal element and the second birefringent crystal.

12. A device as recited in claim 1, wherein the mounting surface further includes a well proximate the protruding contact tip region.

13. A device as recited in claim 1, wherein the isolator arrangement is disposed in a collimated light beam path between first and second collimator units.

14. A device as recited in claim 13, wherein the first and second collimator units are single fiber collimator units.

15. A device as recited in claim 13, wherein the first collimator unit is a dual fiber collimator unit and the second collimator unit is a single fiber collimator unit.

16. A device as recited in claim 15, further comprising a filter disposed between the dual fiber collimator unit and the single fiber collimator unit, the isolator arrangement being disposed between the filter and the single fiber collimator unit.

17. An optical system, comprising:
an optical transmitter producing output light;
an optical receiver receiving at least a portion of the output light; and
an optical fiber link coupling between the optical transmitter and the optical receiver, the optical fiber link including a fiber isolator device having
an isolator arrangement of at least a first birefringent crystal, a non-reciprocal element and a second birefringent crystal forming an isolator unit,
a mount having a first mounting surface provided with a first protruding contact region;
at least one of the first birefringent crystal, the non-reciprocal element and the second birefringent crystal having a second mounting surface contacting the protruding contact region; and
adhesive attachingly disposed between portions of the first and second mounting surfaces not in mutual contact.

18. A system as recited in claim 17, wherein the fiber isolator device includes two fiber collimator units, the isolator arrangement being disposed between the two collimator units, and further comprising a filter disposed between the two collimator units.

19. A system as recited in claim 17, further comprising one or more optical amplifier units disposed on the optical fiber link between the optical transmitter and the optical receiver.

20. A system as recited in claim 17, wherein the optical transmitter includes modulated light sources operating at different wavelengths and optical combining elements to combine outputs from the modulated light sources into a fiber output coupled to the optical fiber link.

21. A system as recited in claim 17, wherein the optical receiver includes optical separating elements to separate different wavelengths of light received from the optical fiber link and to direct light at different wavelengths to respective detectors.

22. A system as recited in claim 17, further comprising an optical add/drop multiplexer disposed on the optical fiber link.

23. A method of mounting optical elements to a mount in an optical isolator for use in a predetermined temperature range, the mount having a first protruding contact region on a mounting surface, and the isolator having an isolator arrangement that includes at least a first birefringent crystal, a non-reciprocal element and a second birefringent crystal, the method comprising:
providing adhesive between at least one of the first birefringent crystal, the non-reciprocal element and the second birefringent crystal;
pressing the at least one of the first birefringent crystal, the non-reciprocal element and the second birefringent crystal into contact with the first protruding contact region thereby substantially expelling the adhesive from between the at least one of the first birefringent crystal, the non-reciprocal element and the second birefringent crystal and the first protruding contact region; and
curing the adhesive at a temperature exceeding the predetermined temperature range.

24. A method as recited in claim 23, further comprising pressing a second of the first birefringent crystal, the non-reciprocal element and the second birefringent crystal against a second protruding contact region of the mount to expel adhesive from between the second of the first birefringent crystal, the non-reciprocal element and the second birefringent crystal and the second protruding contact region.

25. A method as recited in claim 24, further comprising pressing a third of the first birefringent crystal, the non-reciprocal element and the second birefringent crystal against a third protruding contact region of the mount to expel adhesive from between the third of the first birefringent crystal, the non-reciprocal element and the second birefringent crystal and the third protruding contact region.

26. A method as recited in claim 23, wherein providing the mount with a protruding contact region includes providing the protruding co tact region as at least part of a ring around a light transmission aperture of the mount.

27. A method as recited in claim 23, wherein providing the mount with a protruding contact region includes providing at least three individual contact tips on the mounting surface to define a mounting plane.

28. A method as recited in claim 23, wherein providing the adhesive includes providing a thermally curing epoxy between the at least one of the first birefringent crystal, the non-reciprocal element and the second birefringent crystal and the mount.

29. A method as recited in claim 23, further comprising curing the adhesive between the mounting surface and the at least one of the first birefringent crystal, the non-reciprocal element and the second birefringent crystal optical element while the protruding contact region contacts the at least one of the first birefringent crystal, the non-reciprocal element and the second birefringent crystal.

30. A method as recited in claim 23, wherein, after curing, the adhesive remains under tension for temperatures within the predetermined temperature range.

31. A method as recited in claim 23, wherein providing the adhesive includes providing thixotropic adhesive.

32. A method as recited in claim 23, further comprising translating the non-reciprocal element in a direction perpendicular to an axis of the mount, between two raised members, and adhering the non-reciprocal mount over a light aperture of the mount.
